(19) United States
(12) Patent Application Publication
(10) Pub. No.: US 2025/0130073 A1
(43) Pub. Date: Apr. 24, 2025

(54) WIRELESS SCREEN

(71) Applicant: SAGEMCOM ENERGY & TELECOM SAS, BOIS-COLOMBES (FR)

(72) Inventors: Henri TEBOULLE, BOIS-COLOMBES (FR); Patrick GINESTET, BOIS-COLOMBES (FR)

(21) Appl. No.: 18/920,150

(22) Filed: Oct. 18, 2024

(30) Foreign Application Priority Data
Oct. 20, 2023 (FR) FR2311401

(51) Int. Cl. G01D 4/00; G01D 4/02

(52) U.S. Cl. CPC G01D 4/002; G01D 4/02; G01D 2204/18

(57) ABSTRACT

A display device arranged to be integrated in an apparatus that further includes a housing and main circuit. The display device has a screen arranged to be positioned on the housing, a printed circuit on which the screen is mounted and on which there are mounted a first communication interface arranged to receive uplink data transmitted by the main circuit via wireless communication, a display component arranged to cause the screen to display the uplink data, and a power supply circuit.

The invention relates to the field of apparatus provided with a screen and, in particular but not exclusively, to electricity meters and water meters.

### BACKGROUND OF THE INVENTION

Most new electricity meters comprise an LCD (Liquid Crystal Display) screen positioned on the front face of the housing. On some of these meters, pushbuttons “+” and “−” make it possible to scroll through the information displayed and even sometimes to communicate with the motherboard of the meter, for example to order the closing of a cut-off member integrated in the meter.

Integrating the LCD screen in the meter creates a number of issues.

The LCD may be mounted on a printed circuit which is then connected to the motherboard of the meter.

The printed circuit of the LCD screen may be soldered to the motherboard, which causes the following problems.

During maintenance operations on the LCD screen, it may be necessary to unsolder the printed circuit of the LCD screen from the motherboard, which is a relatively complex operation.

Moreover, positioning components on the motherboard facing the entirety of the surface area of the printed circuit of the LCD screen is generally avoided since access to these components, which might be necessary for maintenance operations, would require the printed circuit of the LCD screen to be unsoldered. The result is then a loss of a large amount of surface area for installing components on the motherboard.

The printed circuit of the LCD screen can also be connected to the motherboard by means of rigid metal strips of the HE14 type.

The printed circuit of the LCD screen, or even the LCD screen itself, can also be connected to the motherboard by means of ribbon cables.

These solutions make assembling the meter in the factory more difficult and take up a relatively large amount of space, both on the motherboard and between the motherboard and the printed circuit of the LCD screen. They are also relatively expensive.

### OBJECT OF THE INVENTION

The object of the invention is to simplify the assembly of an apparatus incorporating a screen, to ease maintenance operations, to reduce the cost of the apparatus and to limit the space required by the screen and the impact that its presence has on the installation of components in the apparatus.

### SUMMARY OF THE INVENTION

To achieve this object, a display device is proposed which is arranged to be integrated in an apparatus that further comprises a housing and a main circuit integrated in the housing, the display device comprising:
a screen arranged to be positioned on the housing;
a printed circuit on which the screen is mounted and on which there are mounted:
   a first communication interface arranged to receive uplink data transmitted by the main circuit via wireless communication;
   a display component arranged to cause the screen to display the uplink data;
      a power supply circuit arranged to power the display device.

The display device therefore forms a fully integrated block which communicates, via wireless communication, with the main circuit of the apparatus in which it is installed.

This solution is extremely advantageous since there is no longer any need to provide a connection that requires contact (wires, connectors, ribbon cables, etc.) between the screen and the main circuit in order to transmit the data that are to be displayed to the screen, thereby solving the problems mentioned above. Advantageously, the power supply circuit of the display device comprises a power source (for example a battery) or receives power via a wireless channel, thereby making it possible to eliminate any connection that requires contact between the display device and the main circuit.

In addition, a display device as described above is proposed in which the first communication interface is also arranged to transmit downlink data to the main circuit via wireless communication, the display device further comprising a second communication interface arranged to produce the downlink data from an interaction with an entity external to the apparatus and to transmit said downlink data to the first communication interface.

In addition, a display device as described above is proposed in which the wireless communication is optical communication.

In addition, a display device as described above is proposed which the wireless in communication is radiofrequency communication.

In addition, a display device as described above is proposed in which the main circuit may comprise a primary winding, and the power supply circuit comprises a secondary winding, the main circuit being capable of generating a supply current that induces an induced current in the secondary winding, said induced current being used to power the display device.

In addition, a display device as described above is proposed in which the wireless communication is also implemented by means of the primary winding and the secondary winding.

In addition, a display device as described above is proposed in which the power supply circuit comprises a battery.

In addition, a display device as described above is proposed in which the power supply circuit comprises an HE14 connector.

In addition, a cover for a housing of an apparatus is proposed, comprising a display device as described above.

In addition, an apparatus is proposed, comprising a housing, a main circuit and a display device as described above.

In addition, an apparatus as described above is proposed in which the housing comprises a cover to which the printed circuit of the display device is attached by resilient interlocking.

In addition, an apparatus as described above is proposed, the apparatus being an electricity meter or a water meter.

The invention can be better understood in the light of the following description of particular, non-limiting embodiments of the invention.

### BRIEF DESCRIPTION OF THE DRAWINGS

Reference will be made to the accompanying drawings, among which:

FIG. 1 is a simplified cross-sectional view of the base, the cover, the motherboard and the display device of the electricity meter, along a plane perpendicular to the front face of the meter;

FIG. 2 schematically shows the display device and the motherboard according to a first embodiment;

FIG. 3 schematically shows the display device and the motherboard according to a second embodiment;

FIG. 4 schematically shows the display device and the motherboard according to a third embodiment;

FIG. 5 schematically shows the display device and the motherboard according to a fourth embodiment.

### DETAILED DESCRIPTION OF THE INVENTION

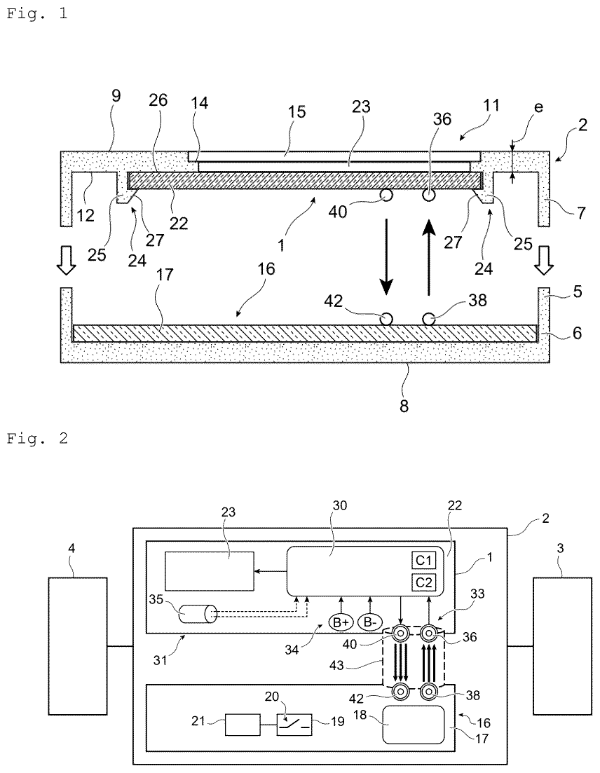

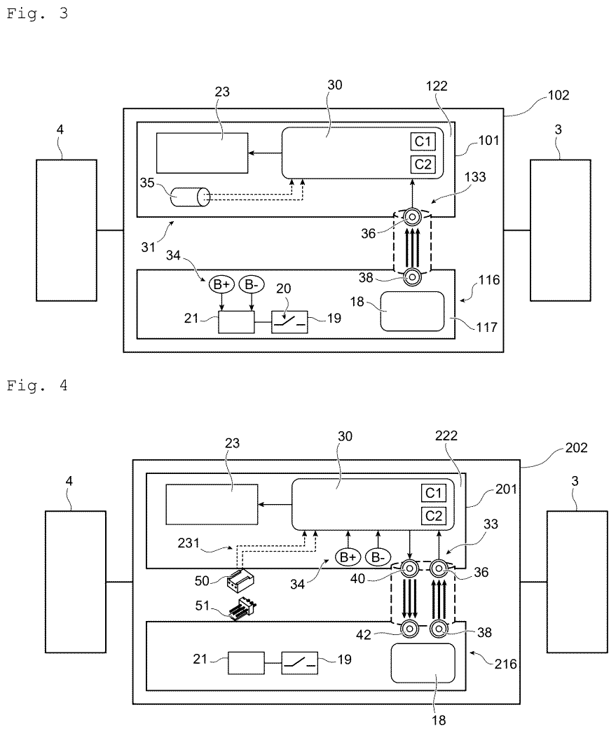

With reference to FIGS. 1 and 2, the display device 1 according to a first embodiment is in this case integrated in an electricity meter 2 which is used to measure the electric power consumed by an installation 3 and supplied by a distribution network 4. The distribution network may be a single-phase or multi-phase network.

The electricity meter 2 comprises a housing 5 (made of plastics material, for example) which comprises a main housing portion, referred to as a base 6, and a cover 7. The base 6 comprises a rear face 8 of the housing 5, which rear face is intended to bear against a wall and be attached to the wall. The cover 7 comprises an external face 9, which is also the front face of the housing 5 and which is visible and accessible for the customer or an operator.

Here, the term “internal” is used to mean on the inside of the meter 2 when the meter is assembled, and the term “external” is used to mean on the outside.

The cover 7, which is attached to the base 6 when the housing 5 is assembled, is removable and can be removed and separated from the base 6 by an operator in order to open the housing 5.

The cover 7 comprises a rectangular opening 11 formed in its thickness e, which has larger dimensions at the external face 9 of the cover 7 than at the internal face 12 thereof. This enlargement of the opening 11 forms a shoulder that defines a surface 14 on which a transparent plate 15 (made of glass or transparent plastics material, for example) is positioned, said transparent plate thus extending over a portion of the front face 9 of the housing 5.

The meter 2 comprises a main circuit, which in this example is an electrical board 16 referred to as a motherboard. The motherboard 16 comprises a printed circuit 17 that is positioned close to and in parallel with the internal face of the base 6.

A number of components are mounted on the printed circuit 17 of the motherboard 16, including a microcontroller 18, referred to here as a “metrology microcontroller”, which, in particular, acquires the measurements taken by the various sensors of the meter 2 and carries out certain processing operations on said measurements.

The meter 2 also includes a cut-off member 19. The cut-off member 19 is intended for selectively cutting off the current supplied to the installation 3. The cut-off member 19 comprises a switch 20 for each phase of the distribution network 4.

The cut-off member 19 is controlled by a microcontroller 21, referred to as an “application microcontroller”, which is mounted on the motherboard 16.

The display device 1 in turn comprises a printed circuit 22, distinct from that of the motherboard 16, and a screen, in this case an LCD screen 23, that is mounted, in this case soldered, on the external face of the printed circuit 22.

The display device 1 is integrated in the meter 2 in the following manner. The edges of the printed circuit 22 are attached to the cover 7 by resilient interlocking. The cover 7 thus comprises tabs 24 which extend from the internal face 12 of the cover 7, perpendicularly thereto, and are each provided with a hook 25 at their free end. A receiving surface 26 is defined on the internal face 12 of the cover 7. The receiving surface 26 extends around the opening 11. The tabs 24 extend on either side of the receiving surface 26. The hooks 25 each comprise a surface 27 that is tilted towards the internal face 12 of the cover 7 and situated beside the receiving surface 26.

When the display device 1 is mounted, the edges of the printed circuit 22 press and slide against the surfaces 27 of the hooks 25, which move apart slightly to allow the printed circuit 22 to pass, being positioned in parallel with the internal face 12 and against the receiving surface 26. The LCD screen 23 is then positioned in the opening formed in the thickness e of the cover 7 such that the external surface of said screen is entirely covered by the transparent plate 15.

When the meter 2 is assembled, the printed circuit 22 is positioned in parallel with the printed circuit 17 of the motherboard 16, typically at a distance of between 1 cm and 6 cm therefrom.

The display device 1 further comprises a display component, in this case a microcontroller 30, referred to here as an “LCD microcontroller”, a power supply circuit 31, a first communication interface 33 and a second communication interface 34. All these components are mounted on the printed circuit 22.

The LCD microcontroller 30 fully controls the LCD screen 23, turning it on and off, powering it and providing it with the data to be displayed in the proper format.

The power supply circuit 31 comprises a battery 35, positioned in an housing attached to the internal face of the printed circuit 22. The power supply circuit 31, and thus the battery 35, powers the entire display device 1. Since the LCD screen 23 is turned off most of the time, there is no critical constraint regarding the lifetime of the battery 35.

The power supply circuit 31 also comprises two capacitors C1, C2, which are mounted on the LCD microcontroller 30 (on two different pins of the microcontroller 30) and make it possible to provide an ad hoc supply complement to guarantee the current supply during current draw peaks by the LCD screen 23. By way of example, each of the capacitors C1 and C2 is formed by a capacitor having a capacitance of 1 μF, in parallel with a capacitor having a capacitance of 68 pF.

The first communication interface 33 is arranged to receive uplink data transmitted by the motherboard 16 via wireless communication. The wireless communication here is optical communication.

The first communication interface 33 comprises a light signal receiver, in this case an infrared photodiode 36.

In turn, the motherboard 16 comprises a light signal emitter, in this case an infrared LED (light-emitting diode) 38.

The photodiode 36 and the LED 38 are positioned facing each other.

The first communication interface 33 of the display device 1 further comprises a light signal transmitter, in this case an infrared LED 40.

In turn, the motherboard 16 comprises a light signal receiver, in this case an infrared photodiode 42.

The LED 40 and the photodiode 42 are positioned facing each other.

The first communication interface 33 is therefore also arranged to transmit downlink data to the motherboard 16.

The meter 1 further comprises an optical guide 43, mounted between the printed circuit 22 of the display device 1 and the printed circuit 17 of the motherboard 16, so as to surround the LEDs 38, 40, the photodiodes 36, 42 and therefore the optical communication channel over its entire length.

The optical guide 43 has a cylindrical shape and makes it possible to guide and concentrate the light signals between the LEDs 38, 40 and the photodiodes 36, 42.

The second communication interface 34 is arranged to produce downlink data from an interaction with an entity external to the meter 2 and to transmit said downlink data to the first communication interface 33 (which in turn transmits them to the motherboard 16). Here, the external entity is an individual (customer or operator a priori).

In this case, the second communication interface 34 comprises two pushbuttons, a “+” button (B+) and a “−” button (B−), which are mounted on the printed circuit 22, are positioned close to the LCD screen 23 and can be actuated from outside the meter 2.

The customer or operator can scroll through the information displayed on the LCD screen 23 by pressing these buttons. The customer or operator can also order the closing of the cut-off member 19 by pressing and holding the button B+.

The second communication interface 34 therefore transforms these commands into downlink data which are then transmitted to the motherboard 16 via the first communication interface 33, so that the motherboard 16 performs the required actions. In this case, these required actions involve causing the LCD screen 23 to display the requested information by transmitting it to the display device 1 via the first communication interface 33, or involve ordering the closing of the cut-off member 19.

The wireless communication is therefore “full-duplex” bidirectional communication that uses an infrared physical layer (LED and photodiode in each communication direction). The communication implements a serial link. By way of example, the protocol used is HDLC (High-Level Data Link Control), based on asynchronous HDLC frames (with, for example, a bit rate of 9600 bits/s and 8-bit asynchronous characters without parity). The sequence of characters to be transmitted is transferred into the payload of the uplink HDLC frame (from the motherboard 16 to the display device 1) byte by byte in ASCII. In the downlink direction, to close the cut-off member 19, an HDLC frame comprising the payload byte 0x01 is sent, for example.

The display device 1 is therefore a fully integrated single block that is autonomous in terms of energy, can be mounted and assembled prior to the assembly of the meter 2 and can have its own reference (Part Number). It can also be integrated with the cover 7 to form a single block having its own reference.

Thus, when assembling the meter 2, it is sufficient to attach the display device 1 to the cover 7 (unless they are already integrated in a single block), in this case by resilient interlocking, and then to attach the cover 7 to the base 6 of the housing 5. No electrical connection needs to be made between the display device 1 and the rest of the meter 2 during assembly, thereby making assembly much simpler and significantly reducing the cost of the meter 2. It is also possible to mount components on the surface of the printed circuit 17 of the motherboard 16, which is located in the projection of the surface of the printed circuit 22 of the display device 1, since said surface is directly accessible when the cover 7 is removed from the housing 2.

With reference to FIG. 3, in a second embodiment, the display device 101 of the meter 102 no longer comprises the second communication interface 34 and therefore no longer comprises pushbuttons B+, B−. The second communication interface 34, and therefore the pushbuttons B+, B−, are no longer positioned on the printed circuit 122 of the display device 101, but on the printed circuit 117 of the motherboard 116. In this case, the pushbuttons B+, B− are connected to the application microcontroller 21.

Downlink communication is therefore no longer required (unidirectional communication is sufficient), so the first communication interface 133 of the display device 101 no longer comprises the LED 40 and the motherboard 116 no longer comprises the photodiode 42.

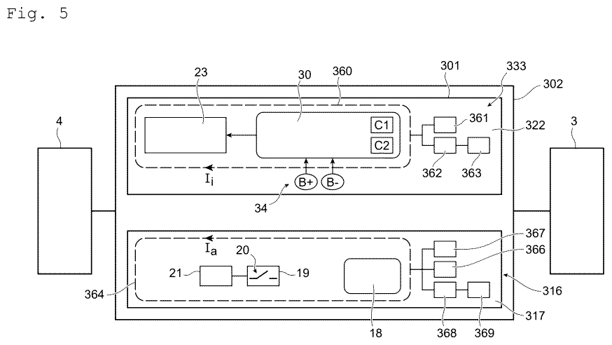

With reference to FIG. 4, in a third embodiment, the display device 201 of the meter 202 no longer comprises a battery 35.

In this case, the power supply circuit 231 comprises a connector 50, in this case a female HE14 connector, mounted on the printed circuit 222 of the display device 201.

The motherboard 216 comprises a complementary connector 51, i.e. male HE14, positioned facing the connector 50.

Thus, when the meter 202 is assembled, the display device 201 is positioned so that the connector 50 connects to the connector 51. The display device 201 is therefore powered by the motherboard 216 by means of the connectors 50, 51.

This embodiment is advantageous over the prior art since the connectors 50, 51 each comprise only two contacts: Vcc (3.3 V for example) and 0 V. The connectors 50, 51 therefore take up very little space on the printed circuits, and in particular on the printed circuit of the motherboard 216.

There is thus indeed a contact connection between the display device 201 and the motherboard 216, but this connection is compact, inexpensive, simple to handle and does not require an unsoldering operation to separate the display device 201 (and the cover 7) from the motherboard 216.

With reference to FIG. 5, in a fourth embodiment, the display device 301 of the meter 302 does not comprise either a battery 35 or a connector 50.

This time, the wireless communication between the display device 301 and the motherboard 316 is radiofrequency communication.

The first communication interface 333 of the display device 301 comprises a secondary winding 360, formed in this case by tracks printed on the internal face of the printed circuit 322. The first communication interface 333 also comprises one or more capacitors 361 connected to the secondary winding 360, as well as a transistor 362 connected to a load 363.

Similarly, the motherboard 316 comprises a primary winding 364, which is formed in this case by printed tracks extending on the internal face of the printed circuit 317 and which, advantageously, has the same dimensions and is arranged coaxially with the secondary winding 360. The motherboard 316 also comprises one or more capacitors 366 connected to the primary winding 364, an amplifier 367, and a transistor 368 connected to a load 369.

The inductance values of the windings 360, 364 and the capacitance values of the capacitors 361, 366 are defined in such a way that, when the meter 302 is assembled and the windings 360, 364 are positioned facing each other, the windings 360, 364 and the capacitors 361, 366 form a resonant circuit at a predefined frequency (for example 13.56 MHZ).

The wireless communication and the powering of the display device 301 take place by means of the primary winding 364 and the secondary winding 360.

The amplifier 367 produces a supply current Ia that flows in the primary winding 364 and generates a magnetic field which induces an induced current Ii in the secondary winding 360. The induced current Ii powers the display device 301.

The uplink communication takes place by means of the transistor 368, which connects or disconnects the load 369 from the primary winding 364 to produce high and low states of the uplink data. This modulates the magnetic field and thus the induced current Ii. This modulation is picked up by a demodulation circuit (not shown) of the first communication interface 333, which then recovers the uplink data. Similarly, the downlink communication takes place by means of the transistor 362, which connects or disconnects the load 363 from the secondary winding 360 and thus modulates the magnetic field, thereby modulating the supply current Ia. This modulation is picked up by a demodulation circuit (not shown) of the motherboard 316, which then recovers the downlink data. In this case, the communication is half-duplex communication.

It goes without saying that the invention is not limited to the embodiments described but comprises any variant falling under the scope of the invention as defined by the claims.

The screen is not necessarily an LCD screen but can be any type of screen (LED, OLED, etc.).

The display device could be attached to the cover in a different way, for example by screwing.

The various embodiments can be combined. In particular, there could be:
a battery in the display device, coupled to any other power supply means (by means of the connectors, wirelessly);
different techniques used for the wireless communication and the wireless power supply (e.g. optical for the communication and radiofrequency for the power supply);
uplink communication and downlink communication in the first communication interface, even without a second communication interface (the LCD microcontroller could, for example, send monitoring data to the motherboard); etc.

The optical communication does not necessarily use infrared signals. The components used may be different (phototransistors instead of photodiodes, for example).

The radiofrequency communication may be performed at a frequency or frequencies different from that stated herein. The windings may be formed not by printed tracks on the printed circuits of the display device and the motherboard but by copper wire coils, patch antennas, etc. The radiofrequency communication does not necessarily use amplitude modulation.

The external entity with which the second communication interface of the display device communicates is not necessarily an individual. It could be external apparatus, a data concentrator or a smartphone, for example, the second communication interface then comprising suitable communication means (radiofrequencies for example).

The main circuit is not necessarily a motherboard of a meter (or the like); it can be any electrical device arranged to send data to a screen to be displayed.

The apparatus including the display device is not necessarily a meter but can be any type of apparatus.

1. A display device arranged to be integrated in an apparatus that further comprises a housing and a main circuit integrated in the housing, the display device comprising:
a screen arranged to be positioned on the housing; and
a printed circuit on which the screen is mounted and on which there are mounted:
a first communication interface arranged to receive uplink data transmitted by the main circuit via wireless communication;
a display component arranged to cause the screen to display the uplink data; and
a power supply circuit arranged to power the display device.

2. The display device according to claim 1, wherein the first communication interface is also arranged to transmit downlink data to the main circuit via wireless communication, the display device further comprising a second communication interface arranged to produce the downlink data from an interaction with an entity external to the apparatus and to transmit said downlink data to the first communication interface.

3. The device according to claim 1, wherein the wireless communication is optical communication.

4. The display device according to claim 1, wherein the wireless communication is radiofrequency communication.

5. The display device according to claim 1, wherein the main circuit comprises a primary winding, and the power supply circuit comprises a secondary winding, the main circuit being capable of generating a supply current that induces an induced current in the secondary winding, said induced current being used to power the display device.

6. The display device according to claim 5, wherein the wireless communication is radiofrequency communication, and wherein the wireless communication is also implemented by means of the primary winding and the secondary winding.

7. The display device according to claim 1, wherein the power supply circuit comprises a battery.

8. The display device according to claim 1, wherein the power supply circuit comprises an HE14 connector.

9. A cover for a housing of an apparatus, comprising a display device according to claim 1.

10. An apparatus comprising a housing, a main circuit and a display device according to claim 1.

11. The apparatus according to claim 10, wherein the housing comprises a cover to which the printed circuit of the display device is attached by resilient interlocking.

12. The apparatus according to claim 10, the apparatus being an electricity meter or a water meter.
